(19) United States
(12) Patent Application Publication
(10) Pub. No.: US 2005/0138290 A1
(43) Pub. Date: Jun. 23, 2005

(54) System and method for instruction rescheduling

(75) Inventors: Per H. Hammarlund, Hillsboro, OR (US); Avinash Sodani, Portland, OR (US); James D. Allen, Austin, TX (US); Ronak Singhal, Beaverton, OR (US); Francis X. McKeen, Portland, OR (US); Hermann W. Gartler, Portland, OR (US)

Correspondence Address: KENYON & KENYON, 1500 K STREET, N.W., SUITE 700, WASHINGTON, DC, 20005, US

(73) Assignee: INTEL CORPORATION

(21) Appl. No.: 10/743,142

(22) Filed: Dec. 23, 2003

(51) Int. Cl. G06F 12/00

(52) U.S. Cl. 711/118

(57) ABSTRACT

Embodiments of the present invention relate to selectively re-executing instructions in a computer processor based on their association with a particular cache miss.

### BACKGROUND

In a computer processor, program instructions may progress through a pipeline comprising a number of overlapping stages. For efficient processing it is desirable to introduce new instructions into the pipeline and have them flow through at as high and as steady a rate as achievable. Sometimes, however, conditions may slow the rate of flow of new instructions through the pipeline. One such condition is the need to re-execute instructions.

Instructions in a pipeline may need to be re-executed, for example, due to a “cache miss.” As is well known, a cache is typically a small, fast memory device located near the execution logic of a computer. Data needed by the execution logic for the near term may be kept in the cache to reduce the latency associated with accessing main memory for the needed data. A cache miss occurs when the needed data is not present in the cache and an access to main memory must be made to retrieve the data. If an instruction executed in a pipeline cannot produce a valid result due to a cache miss, it must be re-executed after the cache miss is “serviced” (where “servicing” a cache miss means that the needed data absent from the cache is read from main memory into the cache).

One known technique for handling an instruction needing re-execution due to a cache miss involves simply re-executing the instruction (regardless of whether the cache miss has been serviced), possibly a number of times, until the cache miss is serviced and the instruction can generate valid results and exit the pipeline. However, this approach wastes both power and execution bandwidth that could otherwise be used for executing new instructions. Another known technique involves enqueuing instructions that generate cache misses, where a number of instructions may each generate a different cache miss, and after any one of the different cache misses is serviced, re-executing all of the enqueued instructions. Such an enqueuing technique, in contrast to the technique of simply re-executing instructions, frees up execution bandwidth and lowers power consumption. However, the enqueuing technique is inefficient in that it does not discriminate with respect to which instructions are associated with the cache miss that is serviced. Typically, the cache miss that is serviced will only be associated with a small subset of the enqueued instructions (e.g., an independent instruction and those instructions dependent on it). Therefore, the data that is retrieved in servicing the cache miss will only be of use to this small subset, even though all of the enqueued instructions are re-executed. Thus, this approach also wastes power and execution bandwidth.

### BRIEF DESCRIPTION OF THE DRAWINGS

FIG. 1 shows a system according to embodiments of the present invention;

FIG. 2 shows an example of an instruction with an association field according to embodiments of the present invention;

FIG. 3 shows a process flow according to embodiments of the present invention; and

FIG. 4 is a block diagram of a computer system, which includes one or more processors and memory for use in accordance with an embodiment of the present invention.

### DETAILED DESCRIPTION

Embodiments of the present invention relate to selectively re-executing instructions based on their association with a particular cache miss. According to the embodiments, when an instruction must be re-executed due to a cache miss, an association may be formed between the instruction and the corresponding cache miss. A plurality of such instructions, each associated with some specific cache miss, may be enqueued to wait for their respective cache misses to be serviced. When a given cache miss is serviced, the instructions associated with the cache miss may be re-executed. In this way, only when the data that they need is present in the cache will the instructions be re-executed. Moreover, only the subset of the enqueued instructions associated with a particular cache miss will be re-executed when the cache miss is serviced. Therefore, the needless consumption of power and execution bandwidth entailed in prior known techniques is avoided.

FIG. 1 shows a system 100 according to embodiments of the present invention. More specifically, FIG. 1 shows elements of a computer processor, where integrated circuit logic is shown as labeled rectangular blocks connected by directed lines. Certain of the elements shown in FIG. 1 are conventional. Many known processors include a “front end” 101 typically associated with the operations of fetching and decoding instructions, a scheduler 104 to schedule the instructions, execution logic and associated cache 106 coupled to the scheduler 104 to execute the instructions, a memory system 105 coupled to the execution logic and cache 106 to hold instructions and data, and retire logic 108 coupled to the execution logic and cache 106 to perform operations associated with the exit of an instruction from a processor pipeline.

According to embodiments of the present invention, the system 100 may further comprise a re-scheduler 102, a priority network 103, and association logic 107. The re-scheduler 102 may be coupled to the front end 101, the priority network 103, the memory system 105, and the association logic 107. The association logic 107 may further be coupled to the execution logic and cache 106. The priority network 103 may further be coupled to the scheduler 104.

The system 100 may be viewed as representing at least a portion of physical structures and mechanisms for implementing a processor pipeline. Accordingly, a progress of an instruction through logic blocks as shown in FIG. 1 may be viewed as paralleling its progress through a corresponding pipeline. To illustrate operations according to embodiments of the present invention, an example of a progression of an instruction through the system 100 is discussed in the following.

Assume an instruction, I1, is fetched and decoded as part of operations associated with front end logic 101. Conventionally (in the absence of the re-scheduler 102 and priority network 103), the instruction might then proceed to the scheduler 104. The scheduler 104 may determine when an instruction is ready to execute, based on such factors as whether its dependencies are satisfied. According to embodiments of the present invention, on the other hand, instruction I1 may proceed to the scheduler 104 via the re-scheduler 102 and the priority network 103. The I1 instruction may be one of a plurality of instructions in the re-scheduler 102, and the priority network 103 may determine which of the plurality of instructions has priority. Priority may be based, for example, on the comparative “ages” of the instructions (i.e., how long, in comparative terms, each instruction has been waiting in the re-scheduler 102). Based on its priority, an instruction may be forwarded to the scheduler 104 and be scheduled for execution in due course. When an instruction is written into the re-scheduler by the front end, it may be immediately eligible to execute.

Now assume that I1 is scheduled for execution and proceeds to the execution logic and cache 106. Further assume that I1 requires data for its execution that is not present in the cache. For example, I1 could be a “load” instruction that needs to move data currently in memory of the memory system 105 (but not in the cache) to a physical register. Because the data needed by I1 is not in the cache, a cache miss may be generated, and a sequence of operations to read the needed data from the memory system 101 into the cache may be initiated to service the cache miss. As this sequence of operations typically requires a number of machine cycles and other instructions are typically awaiting execution in the pipeline, instruction I1 may be enqueued for re-execution to allow other instructions to execute while the cache miss is serviced.

As discussed above, in prior known techniques I1 might simply have been re-executed, possibly a number of times even though its cache miss had not yet been serviced, until its cache miss was serviced and I1 was able to execute successfully, retire and exit the pipeline. Or, I1 might have been enqueued along with other instructions that generated cache misses, and all of these enqueued instructions might have been re-executed when any cache miss was serviced, regardless of which instruction generated the cache miss. By contrast, according to embodiments of the present invention, I1 may be associated with the specific cache miss that was generated by the execution of I1. To form the association, according to embodiments an identifier may be assigned to the specific cache miss generated by I1, and the identifier may be associated with I1. The identifier may be assigned by the association logic 107.

Instruction I1 together with the association may then be returned to the re-scheduler 102. Instruction I1 may have been followed by one or more dependent instructions in the pipeline that were also scheduled for execution. Known systems exist for propagating output data generated by an instruction to its dependent instructions; such systems, for example, may be built into the execution logic and cache 106, and further utilize a “bypass network” and the processor's physical register file (not shown). As discussed in more detail further on, embodiments of the present invention may utilize such systems to also propagate the association formed between a load instruction and a corresponding cache miss to instructions dependent on the load instruction. The dependent instructions together with their respective associations may also be returned to the re-scheduler 102. Thus, in the example under discussion, instructions dependent on I1, together with their respective associations, may be returned to the re-scheduler 102. When instruction I1 and its dependent instructions are written into the re-scheduler 102 they may be designated as not eligible to execute.

Other independent instructions may follow I1, generate cache misses, be associated with their respective cache misses using an identifier assigned by the association logic 107, returned to the re-scheduler 102 and designated as not eligible to execute. Instructions dependent on those other independent instructions may also be associated with the same cache miss as their respective corresponding independent instructions, returned to the re-scheduler 102 and designated as not eligible to execute. The instructions returned to the re-scheduler 102 may remain there, awaiting re-execution while their associated cache misses are serviced. In the meantime, on the other hand, new instructions may continue to flow through the pipeline. The new instructions may execute successfully and become ready to retire, unimpeded by the instructions returned to the re-scheduler 102, thus achieving efficient throughput of instructions in the pipeline.

The memory system 105 may be responsible for servicing the cache misses for the instructions waiting in the re-scheduler 102. In conventional systems, to service a cache miss, a request may be issued to memory system 105. As part of the request, the memory system 105 may be given an address of the cache line that “missed” (the cache 106 did not contain needed data); the memory system may then begin operations to retrieve the data needed for the cache from memory and place it into the cache line corresponding to the address. According to embodiments of the present invention, the memory system may further be given the identifier of the cache miss associated with the instruction that generated the cache miss.

When the memory system 105 has completed servicing a cache miss, it may notify the re-scheduler 102. For example, the memory system 105 may send a signal to the re-scheduler 102 broadcasting the identifier for the cache miss just serviced. Based on the signal from the memory system 105, the re-scheduler 102 may cause those instructions associated with the cache miss just serviced to be designated as eligible for re-execution. The eligible instructions may then be re-executed (in accordance with their priority as determined by the priority network 103), produce valid results since the needed data is now present in the cache, proceed through retire logic 108 and exit the pipeline.

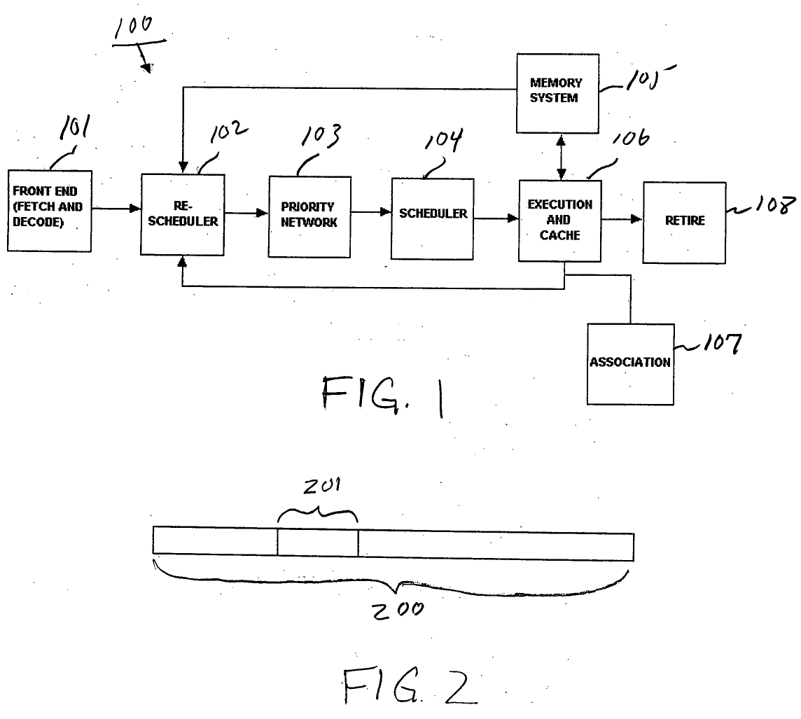

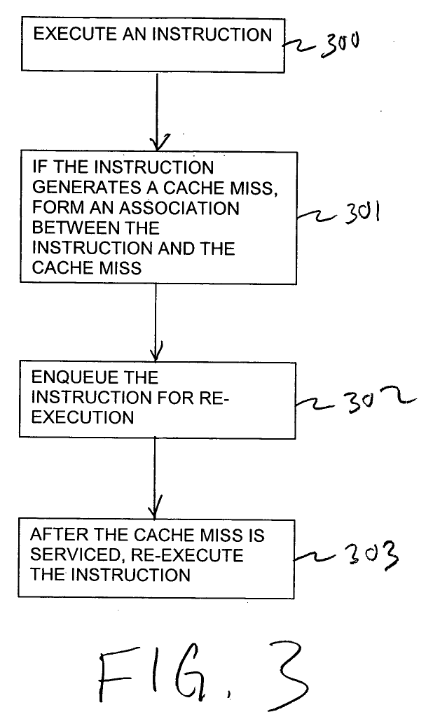

FIG. 2 shows one possible arrangement for associating instructions with their respective cache misses according to embodiments of the present invention. As is well understood, an instruction 200 may be a string of bits encoding some operation to be performed by execution logic, such as loading a register with data. According to embodiments, an association field 201 may be provided in an instruction 200 to encode an identifier of a cache miss. If, for example, the association field 201 was four bits long, sixteen distinct cache misses could be represented by field 201.

A default value of all zeroes could be initially assigned to the association field 201 of an instruction on its first pass through the pipeline, to indicate that as yet no cache miss had been generated as a result of executing the instruction. If no cache miss were generated by the instruction, it would simply execute and retire with its association field 201 unmodified. If, on the other hand, the instruction generates a cache miss when it executes, the association logic 107 may assign one of a plurality of possible identifiers to the cache miss, and the identifier may be written in the association field 201 of the instruction. For example, returning to the example of I1, assume that I1 has an association field 201 of four bits, and that three cache misses have occurred prior to the execution of I1 that have not yet been serviced. When I1 executes and generates a cache miss, the association logic 107 could determine that of the sixteen possible unique identifiers available in a four bit code, three (say, for example, “0001”, “0010” and “0011”) had been allocated to previous instructions. Accordingly, the association logic 107 could assign the next available unique identifier, “0100”, to the cache miss generated by I1. The identifier “0100” could be written in I1's association field, and I1 could be returned to the re-scheduler 102. The identifier “0100” could also be propagated to any instructions dependent on I1 that were scheduled for execution, and these could also be returned to the re-scheduler 102. There, I1, and possibly instructions dependent on I1, could await servicing of the cache miss assigned the identifier “0100”.

As noted above, existing systems may be used to propagate the association of a cache miss with a load instruction to instructions dependent on the load instruction. More specifically, in known systems, when a load instruction executes, it writes data from the cache into a register in the processor's physical register file. Instructions dependent on the load instruction then read the data from the register file. When a load instruction “misses the cache” (i.e., the data that the load instruction needs is not present in the cache), the following may occur: (i) the load instruction typically still writes whatever data was present in the cache to the register file, notwithstanding that it is incorrect data; and (ii) the cache logic determines that a cache miss has occurred and this information is used as a basis for re-executing or enqueing the load instruction for re-execution, and for initiating servicing of the cache miss by the memory system. According to embodiments of the present invention, part (i) of the foregoing mechanism may be used to propagate the association formed with a cache miss to dependent instructions. In the embodiments, when a load instruction misses the cache and the association logic 107 assigns an identifier to the cache miss, the association logic 107 may provide the identifier to the load instruction, which then writes the identifier, along with the data read from the cache, to the register file. Instructions dependent on the load instruction may then read the register file, whereupon, based on the identifier, it may be detected that the load missed the cache and that the identifier should be associated with each dependent instruction reading the register file. The identifier may accordingly be associated with each dependent instruction (e.g., written into its association field) and each dependent instruction may be enqueued in the re-scheduler 102.

Returning to the example of load instruction I1, in a request issued to the memory system to service the cache miss, the memory system 105 may be given the address of the missed cache line and the identifier “0100”. When the memory system 105 finished servicing the cache miss by placing the needed data in the corresponding address, it could send a signal representing “0100” to the re-scheduler 102. This signal could be used as an indication that the instructions having “0100” encoded in their association fields are eligible for re-execution. For example, each instruction in the re-scheduler could further include a “ready” field to indicate whether or not the instruction was eligible for re-execution. The signal from the memory system 105 could be broadcast to each instruction in the re-scheduler 102 to set the appropriate ready field(s) to indicate eligibility for re-execution. For example, the signal from the memory system could be sent through some combinational logic together with the association field of the instructions to set the ready field to indicate eligibility for re-execution when the signal corresponds to the association field. Those instructions having their ready fields set to indicate eligibility for re-execution might accordingly be re-executed in accordance with their priority as determined by the priority network 103.

Identifiers may be made available in the association logic 107 for re-assignment to new cache misses when memory requests complete. However, it is possible that in some circumstances the number of cache misses may outnumber unique identifiers available to be assigned to the cache misses (e.g., a four bit association field only allows for only 16 unique identifiers of cache misses (or 15 if encoding “0000” is used to indicate no miss), and 17 or more cache misses may occur). In this eventuality, the same identifier may be assigned to cache misses that are distinct. However, this situation still allows for more selectivity in instruction re-execution than prior known arrangements, even though some instructions may be re-executed whose corresponding cache misses have not actually been serviced yet.

Some instructions may have multiple dependencies. Thus, according to embodiments of the present invention, a single instruction could be associated with multiple cache misses by techniques along the lines described above. The single instruction might be enqueued in the re-scheduler 102 and only designated eligible for re-execution after all of its associated cache misses had been serviced.

FIG. 3 shows a process flow according to embodiments of the present invention. As shown in block 300, the process may include executing an instruction. The process may further include, if executing the instruction generates a cache miss, associating the instruction with the cache miss as shown in block 301.

The instruction may be enqueued for re-execution, as shown in block 302. As shown in block 303, after the cache miss associated with the instruction is serviced, the instruction may be re-executed.

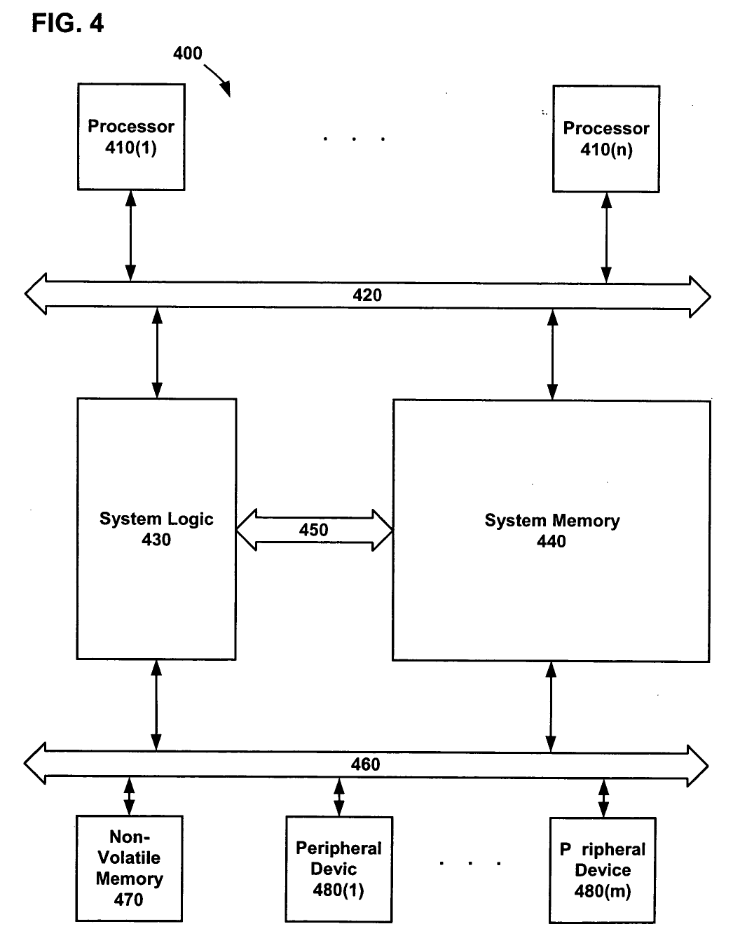

FIG. 4 is a block diagram of a computer system, which may include an architectural state, including one or more processors and memory for use in accordance with an embodiment of the present invention. In FIG. 4, a computer system 400 may include one or more processors 410(1)-410(n) coupled to a processor bus 420, which may be coupled to a system logic 430. Each of the one or more processors 410(1)-410(n) may be N-bit processors and may include a decoder (not shown) and one or more N-bit registers (not shown). System logic 430 may be coupled to a system memory 440 through a bus 450 and coupled to a non-volatile memory 470 and one or more peripheral devices 480(1)-480(m) through a peripheral bus 460. Peripheral bus 460 may represent, for example, one or more Peripheral Component Interconnect (PCI) buses, PCI Special Interest Group (SIG) PCI Local Bus Specification, Revision 2.2., published Dec. 18, 1998; industry standard architecture (ISA) buses; Extended ISA (EISA) buses, BCPR Services Inc. EISA Specification, Version 3.12, 1992, published 1992; universal serial bus (USB), USB Specification, Version 1.1, published Sep. 23, 1998; and comparable peripheral buses. Non-volatile memory 470 may be a static memory device such as a read only memory (ROM) or a flash memory. Peripheral devices 480(1)-480(m) may include, for example, a keyboard; a mouse or other pointing devices; mass storage devices such as hard disk drives, compact disc (CD) drives, optical disks, and digital video disc (DVD) drives; displays and the like.

Several embodiments of the present invention are specifically illustrated and/or described herein. However, it will be appreciated that modifications and variations of the present invention are covered by the above teachings and within the purview of the appended claims without departing from the spirit and intended scope of the invention.

1. A method comprising:
executing a first instruction in a processor;
if the execution of the first instruction generates a cache miss, associating the first instruction with the cache miss;
enqueuing the first instruction for re-execution; and
after the cache miss with which the first instruction is associated is serviced, re-executing the first instruction.

2. The method of claim 1, further comprising associating the cache miss with a second instruction dependent on the first instruction.

3. The method of claim 1, further comprising assigning an identifier to the cache miss.

4. The method of claim 1, further comprising determining a priority of the instruction.

5. A processor comprising:
a re-scheduler to hold instructions enqueued for execution; and
association logic to form an association between a cache miss and an instruction generating the cache miss, the instruction to be enqueued in the re-scheduler.

6. The processor of claim 5, wherein the re-scheduler is further coupled to priority logic to determine a priority of instructions in the re-scheduler.

7. The processor of claim 5, wherein the association logic is to assign an identifier to the cache miss.

8. The processor of claim 5, wherein the re-scheduler is to receive a signal indicating that the cache miss corresponding to the association has been serviced.

9. The processor of claim 8, wherein the re-scheduler is to cause an instruction to be designated as eligible for re-execution based on the signal.

10. A method comprising:
generating a cache miss in a processor;
assigning an identifier to the cache miss and writing the identifier in a field of a load instruction generating the cache miss;
issuing a request to service the cache miss to a memory system of the computer and providing the identifier to the memory system;
placing the load instruction in a queue for re-execution, where an eligibility of the instruction for re-execution is based at least in part on the identifier;
after the memory system completes servicing the request, causing the memory system to provide the identifier to the queue; and
designating the load instruction as eligible for re-execution based on the identifier provided by the memory system.

11. The method of claim 10, further comprising re-executing the load instruction based on receiving the identifier from the memory system.

12. The method of claim 10, further comprising propagating the identifier to any instruction dependent on the load instruction.

13. A method comprising:
in a processor, enqueuing a plurality of instructions needing re-execution due to respective cache misses in a re-execution queue;
associating each instruction in the queue with a respective corresponding cache miss; and
after a cache miss is serviced, re-executing those instructions in the re-execution queue associated with the serviced cache miss.

14. The method of claim 13, further comprising determining a priority of the instructions.

15. The method of claim 13, wherein the associating comprises writing an identifier of a cache miss in an instruction.

16. A system comprising:
a memory system to hold instructions for execution;
a processor coupled to the memory system, the processor including:
a re-scheduler to hold instructions from the memory system enqueued for execution; and
association logic to form an association between a cache miss and an instruction generating the cache miss, the instruction to be enqueued in the re-scheduler.

17. The system of claim 16, wherein the re-scheduler is further coupled to priority logic to determine a priority of instructions in the re-scheduler.

18. The system of claim 16, wherein the association logic is to assign an identifier to the cache miss.
